(19) United States
(12) Patent Application Publication
(10) Pub. No.: US 2004/0221395 A1
(43) Pub. Date: Nov. 11, 2004

(54) Composition for treating leather containing aqueous polymer dispersions, film-forming in the absence of organic solvent

(76) Inventors: Claudine Biver, Nanterre (FR); Xavier Drujon, Dunkerque (FR); Ludwik Leibler, Paris (FR); Emeryc Valot, Viroflay (FR)

Correspondence Address: WHYTE HIRSCHBOECK DUDEK S C, 555 EAST WELLS STREET, SUITE 1900, MILWAUKEE, WI, 53202, US

(21) Appl. No.: 10/239,681

(22) PCT Filed: Mar. 20, 2001
(86) PCT No.: PCT/FR01/00825

(30) Foreign Application Priority Data
Mar. 24, 2000 (FR) 00/03798

(51) Int. Cl. C14C 1/00

(52) U.S. Cl. 8/94.15

(57) ABSTRACT

The invention concerns leather finish compositions containing at least an aqueous dispersion of film-forming polymer at room temperature without cosolvent, or plasticizing agent and optionally a cross-linking agent. Said dispersions free of organic solvent provide non-sticky and abrasion resistant coatings with good water resistance. Said dispersions consist of structured polymer particles having one or more soft phases (Tg<20° C.) and one or more hard phases (Tg>60° C.).

The invention relates to the field of aqueous polymer dispersions which are used in compositions for leather treatment. It relates in particular to aqueous film-forming polymer dispersions without a coalescing solvent and to their use in formulations for leather finishing.

It is well known to a person skilled in the art that the finish on leather depends on the quality of the hide to be treated. For full grain or corrected grain leathers, the finish, without modifying the appearance of the grain, should introduce a degree of protection to the substrate. In contrast, on a split, the systematically pigmented finish makes it possible to reconstitute an artificial grain and introduces the characteristics required according to the final use of the leather.

Depending on the quality of the leather and its final use, the finish is composed of two or three superimposed layers. The first, in contact with the leather and generally very supple, constitutes the base coat. Depending on the final application, it may be transparent but colored or covering and therefore pigmented. The second coat or seasoning coat conventionally has a moderate hardness. It is often colored but is not very covering. The external coat, known as the fixing coat, is always transparent. This is the coat subject to the greatest stresses. It should therefore have the best performance. It generally possesses a high hardness (between 60 and 90 Shore A), good resistance to rubbing movements under dry conditions or in the presence of water and good adhesion.

Resins for binders are often in solution in organic solvents. The most widely used resins are polyurethanes, which are relatively expensive, protein compounds or nitrocelluloses, which, insofar as they are provided in a solvent, present potential risks of toxicity and of flammability during formulation or application. These resins are often formulated with a crosslinking agent.

There exist a few binders dispersed in the aqueous phase, generally polyurethanes, such as the Bayerderm® compounds 60, 80, 85 or 90 UD from Bayer, but these resins, because of their manufacturing process, also contain solvent residues.

Several patents disclose the possibility of using acrylic polymers with a core-shell structure in dispersion in water.

Patents U.S. Pat. No. 4,876,313, U.S. Pat. No. 4,916,171 and EP 0 348 565 provide, for example, for the use of such polymers in which the shell is rendered alkali-soluble by the introduction of a high content of acidic monomers, typically of the order of 10 to 60% by weight with respect to the monomers constituting the shell. The disadvantage of this type of product, with a high content of acidic functional groups, is their high sensitivity to water.

U.S. Pat. No. 5,185,387 discloses the use of latices with a core-shell structure, in which latices the core has a glass transition temperature (Tg) of less than 0° C. and the uncrosslinked shell has a glass transition temperature of less than 60° C. The main disadvantage of these copolymers with low Tg values is that they result in coatings which can exhibit surface tack according to the temperature conditions, during application or use.

EP 0 009 258 provides, on the basis of the same latex, for the introduction into the shell of monomers, such as N-methylolacrylamide, which can crosslink during formation of the film and can reduce the surface tack. However, this crosslinking is only possible at a high temperature, typically greater than 120° C., which cannot be envisaged for the treatment of leather, where the temperatures have to be less than 80° C.

U.S. Pat. No. 4,256,809 provides, for the treatment of leather, a homogeneous or structured dispersion comprising polymerizable aldehyde functional groups, such as acrolein or methacrolein, which crosslink at low temperature by the addition, to the serum, of a reactant of dicarboxylic acid bishydrazide type. In point of fact, acrolein is a volatile, inflammable and highly toxic monomer which is currently tending to disappear from all products.

Finally, EP 0 789 082 provides for the use of latices with core-shell structure which are prepared according to a fairly complicated, three-stage process. In these latices, the core has a glass transition temperature of less than 20° C., the shell a glass transition temperature of greater than 20° C., the core and the shell comprises acid groups and the core is crosslinked by being brought into contact with transition metals, such as zinc.

The currently known solutions are therefore not entirely satisfactory insofar as the aqueous compositions provided either contain toxic monomers or solvents, or exhibit sensitivity to water or surface tack, or, finally, are obtained using relatively expensive or complicated processes which appear incompatible with the application envisaged.

The problem remaining to be solved is therefore the preparation of a composition for the treatment of leather comprising little or nothing in the way of solvent, which is easily obtained and which gives nontacky coatings which are resistant to water and to rubbing movements and which have good adhesion to the substrate.

The Applicant Company has found that the use, in a formulation for leather finishing, of aqueous dispersions of polymer particles comprising at least one internal phase formed by a polymer with a soft nature with a glass transition temperature less than 20° C. and at least one external phase formed by a polymer with a hard nature with a glass transition temperature of greater than 60° C. makes it possible to obtain coatings with little or nothing in the way of solvent. These coatings are nontacky and exhibit good adhesion, good resistance to rubbing movements and good behavior toward water. These properties are adjusted by introducing, into the shell, suitable functional monomers which can improve, for example, the adhesion of the coatings, their behavior toward water and their behavior toward solvents. These monomers are chosen in order to make possible optional postcrosslinking. Finally, the feel obtained with these various finishes is very different from that obtained with a polyurethane, acrylic or nitrocellulose-based binder.

The subject matter of the present invention is therefore a composition for the treatment of leather, in particular a composition for finishing and more particularly a binder composition, which comprises such aqueous polymer dispersions, optionally a crosslinking agent and additives known to a person skilled in the art, such as antifoaming agents, wetting agents, thickeners, colorants, fillers, and the like.

The use according to the invention of these aqueous polymer dispersions in leather treatment formulations should make it possible to reduce, indeed even eliminate, the use of cosolvents and plasticizers, resulting in the direct preparation of less flammable and less toxic products.

The formulations for leather treatment according to the invention, in particular the formulations for leather finishing, comprise at least one aqueous dispersion of multiphase particles of polymers, each particle comprising at least two distinct phases:

a first internal phase formed by a polymer P1 with a soft nature having a glass transition temperature (Tg1) of less than 20° C., and

a second external phase, which is alkali-insoluble, formed by a polymer P2 with a hard nature having a glass transition temperature (Tg2) of greater than 60° C.,

and optionally a crosslinking agent.

Preferably, the particles are two-phase and have a core/shell structure.

Preferably, the core comprises the polymer P1 and the shell comprises the polymer P2.

Preferably again, the polymer P1 has a Tg1 of less than 5° C. and the polymer P2 has a Tg2 of greater than 60° C.

The polymer P1 is more hydrophobic than the polymer P2, the polymer P2 comprising at least 50% by weight of hydrophobic monomers and from 0 to 19% by weight of functional monomers preferably chosen from acidic, hydroxylated or epoxidized monomers.

The functional monomers introduced into the polymer P2 can be advantageously crosslinked during the application of the composition to the leather by the introduction, into the aqueous phase, of a suitable crosslinking agent conventionally used in the trade, such as a polyisocyanate, a polyaziridine, a polycarbodiimide, and the like.

Generally, the hydrophobic nature of a polymer is its insolubility in water or else its absence of affinity with respect to water. According to the invention, the hydrophobic nature of a polymer can be defined using the solubility parameter δ described in “Properties of polymers” by D. W. Van Krevelen, 1990, 3rd edition, p. 200. This parameter makes it possible to classify the various polymers according to their affinity with respect to water. According to the invention, a polymer is hydrophobic if its δ is less than 26. Furthermore, if δ1 of a polymer 1 is less than δ2 of a polymer 2, then 1 is more hydrophobic than 2.

The alkali-soluble nature, in contrast with the alkali-insoluble nature, is as defined, for example, in patent EP 0 348 565.

The polymers P1 and P2 of the aqueous dispersions according to the invention advantageously comprise:

from 90 to 100% by weight of units obtained by polymerization of at least one monomer chosen from the group (I) consisting of (C₁-C₁₆)alkyl esters of (meth)acrylic acid, such as methyl (meth)acrylate, ethyl (meth)acrylate and butyl (meth)acrylate, hydroxyalkyl esters of (meth)acrylic acid, vinyl esters of linear or branched carboxylic acids, such as vinyl acetate and vinyl stearate, styrene, alkylstyrenes, such as methylstyrene, haloalkyl-styrenes, such as chloromethylstyrene, (meth)acrylamide, acrylonitrile, vinyl chloride, (meth)acrylic acids and their derivatives, such as anhydrides, monomers comprising acidic or basic functional groups, such as itaconic acid, fumaric acid, crotonic acid or maleic acid, silanated (meth)acrylic or vinyl monomers, such as methacryloxypropyltriethoxy- or methacryloxy-propyltriisopropoxysilane, and monomers comprising acetoacetoxy groups, such as acetoacetoxyethyl (meth)acrylate, and

from 0 to 10% by weight of units obtained by polymerization of at least one monomer chosen from the group (II) consisting of allyl esters of monocarboxylic or dicarboxylic acids, such as allyl acrylate, allyl methacrylate and diallyl maleate or phthalate, conjugated dienes, such as butadiene and isoprene, polyol poly(meth)acrylates, such as ethylene glycol or triethylene glycol dimethacrylate, 1,3- or 1,4-butylene glycol dimethacrylate, 1,4-butanediol diacrylate and pentaerythritol tetraacrylate, or trimethylolpropane triacrylate, polyvinylbenzenes, such as divinylbenzene or trivinylbenzene, and polyallyl derivatives, such as triallyl cyanurate, triallyl isocyanurate and triallyl trimesate.

The term “(meth)acrylate” means either acrylate or methacrylate and the term “(meth)acrylic” means either acrylic or methacrylic.

The monomers of the group (II) act as crosslinking agents in the polymers P1 and P2.

In general, the polymer P1 with a soft nature is composed predominantly of units originating from the polymerization of at least one monomer chosen from butyl acrylate or methacrylate, methyl acrylate or methacrylate, ethyl acrylate or methacrylate, 2-ethylhexyl acrylate or methacrylate, or styrene, whereas the polymer P2 with a hard nature is generally predominantly composed of units originating from the polymerization of at least one monomer chosen from methyl methacrylate, styrene, vinyl chloride, acrylic or methacrylic acid, itaconic acid, maleic acid, or hydroxyethyl acrylate or methacrylate.

The preferred crosslinking monomers are 1,4-butanediol diacrylate, ethylene glycol dimethacrylate, triethylene glycol dimethacrylate and trimethylolpropane triacrylate, the content of crosslinking monomers being between 0 and 10% by weight with respect to the total weight of the particles.

The hard polymer P2 can be grafted directly to the polymer P1 or by the introduction onto the latter of residues from monomer units. These residues from monomer units are obtained by the incorporation into the soft polymer P1 of grafting monomers chosen either from conjugated dienes, the residues from monomer units resulting from the partial incorporation of the diene at the 1,2-position during the polymerization, or from allyl esters of α,β-unsaturated carboxylic or dicarboxylic acids which have two copolymerizable functional groups with different reactivities.

The preferred grafting monomers according to the invention are butadiene, allyl methacrylate and diallyl maleate.

The polymers P1 and P2 according to the invention can be prepared by emulsion polymerization in at least two stages, as described below, from the monomers chosen from the group (I) and optionally the group (II) above.

The selection of the monomers, both for the soft polymer P1 and for the hard polymer P2, is conditioned by the properties which it is desired to confer on the polymers in question and more particularly on the compositions for leather treatment according to the invention. In the case of the binders, mention may be made, as important properties, of:

the resistance to rubbing, which depends on the glass transition temperatures of the polymers P1 and P2,

the adhesion to the lower coats, which depends on the nature of the monomers present in the polymer P2 and on the content of surfactant in the dispersion,

the behavior toward water, which depends on the hydrophobicity of the monomers, on the content of surfactant in the dispersion and on the content of external crosslinking agent.

These aqueous dispersions of multiphase polymer particles exhibit the consistency and the appearance of a latex. The content of dry matter in these dispersions is generally between 10 and 50% by weight, preferably between 20 and 45% by weight. These dispersions can be employed directly, alone or as blends with another acrylic, polyurethane or polyurethane-acrylic latex, in preparing the leather treatment compositions according to the invention. A person skilled in the art knows how to prepare such compositions. A few examples of additives which can be introduced, alone or as mixtures, into the compositions according to the invention are shown below:

An antifoaming agent, at a content preferably of between 0.01% and 2% by weight with respect to the total weight of the composition, for example a silicone or a silicone derivative.

A preservative for preventing the growth of microorganisms. Use is preferably made of between 0.01% and 2% by weight with respect to the total weight of the composition of such an agent, generally chosen from derivatives of imidazolidinylurea type and derivatives of paraben type, such as alkyl parahydroxybenzoates.

A colored, black or white organic or inorganic pigment, such as carbon black, or a dye, at a content suitable for producing the desired coloring performance.

A pH regulator, such as amines, alkali metal hydroxides, ammonium hydroxide or a combination of these additives.

According to the content of functional monomers in the dispersion used, a crosslinking agent for these functional groups will or will not be introduced, this crosslinking agent being chosen from conventional crosslinking agents used in the leather finishing application. Mention may be made, inter alia, of polyaziridines, epoxides, hydrazide derivatives, polyisocyanates and polycarbodiimides. The crosslinking makes it possible to retain a good level of adhesion to leather. It also results in an improvement in the dynamic resistance to the penetration of water and in an improvement in the behavior toward rubbing movements in the presence of water and of organic solvents. The content of crosslinking agent in its commercial presentation is generally between 0 and 20% by weight (expressed with respect to the commercial latex) and preferably between 0.1 and 10%.

The amount of aqueous dispersions of film-forming polymer which is present in the compositions for leather treatment is generally between 10% and 80% by weight, preferably between 20% and 50%, according to the content of active material in the latex. The total content of active material in these compositions for leather treatment is typically between 5 and 30% by weight and preferably between 10 and 20%.

An aqueous dispersion suitable for the preparation of the compositions according to the invention is an aqueous dispersion comprising neither cosolvent nor plasticizer which forms a film by evaporation at a temperature of less than 60° C., the aqueous dispersion according to the invention being composed of particles of hydrophobic polymers structured as a core/shell and comprising from:

70 to 90% by weight of at least one polymer P1 with a soft nature having a Tg of less than 20° C., forming the core, and from

10 to 30% by weight of at least one polymer P2 with a hard nature having a Tg of greater than 60° C., forming the shell.

Preferably, the core has a Tg1 of less than 5° C. and the shell a Tg2 of greater than 60° C. Furthermore, the core is generally more hydrophobic than the shell.

Generally, the aqueous dispersions of the invention are prepared by emulsion polymerization of a mixture of monomers which are composed:

of 90 to 100% by weight of at least one monomer chosen from the group (I) and

of 0 to 10% by weight of at least one monomer chosen from the group (II).

These aqueous dispersions are prepared by emulsion polymerization in at least two stages according to polymerization techniques well known to a person skilled in the art.

The composition of the mixture of monomers to be polymerized at each stage depends on the properties which it is desired to give to the polymers formed (Tg) and to the compositions for leather treatment comprising them (adhesion, resistance to abrasion, behavior toward water).

According to the invention, the polymer P1 with a soft nature and with a Tg1 of less than 20° C., constituting the core of the particles, is prepared in a first stage and subsequently the polymer P2 with a Tg2 of greater than 60° C., constituting the shell with a hard nature, is prepared.

It should be noted that, when the mixture of monomers to be polymerized to form the core is more hydrophobic than that to be polymerized to form the shell, it is easier to obtain well-structured particles.

For each stage, the polymerization reaction is preferably carried out under an inert atmosphere in the presence of radical initiators. The initiating system used can be an oxidation/reduction system or a thermal or peroxide system, such as tert-butyl hydroperoxide/sodium bisulfate or diisopropylbenzene, sodium or potassium persulfate, the amounts used being between 0.2 and 1% by weight with respect to the total mass of the monomers, preferably between 0.25 and 0.5% by weight.

The emulsion polymerization reaction according to the invention is carried out at a temperature of between 25 and 150° C. and depends on the nature of the initiating system used.

The dispersions according to the invention are preferably prepared according to a process of semi-continuous type which makes it possible to restrict the drifts in the compositions which are a function of the differences in reactivity of the various monomers. The introduction of the monomers, either pure or in the form of a preemulsion with a portion of the water and surfactants, is thus generally carried out over a period of time of 3 hours 30 to 5 hours. It is also useful, although not essential, to carry out seeding with 1 to 15% of the monomers. The emulsifying systems used in the emulsion polymerization process are chosen within the range of the emulsifiers having a suitable hydrophilic-lipophilic balance. The preferred systems are composed of the combination of an anionic surfactant, such as sodium lauryl sulfate, ethoxylated nonylphenol sulfates, in particular comprising 20-25 mol of ethylene oxide, dodecylbenzenesulfonate and ethoxylated fatty alcohols, in particular comprising 10-40 mol of ethylene oxide, and ethoxylated fatty alcohols.

The compositions for leather treatment according to the invention are prepared by adding, with stirring, the various desired additives to the dispersion of the film-forming polymer under consideration or, conversely, by adding the dispersion of the film-forming polymer to an aqueous base comprising these additives. The pH of the composition can be adjusted in the final stage, if necessary. The compositions according to the invention can be applied by using techniques known to a person skilled in the art, for example with a brush, with a plush applicator or with a spray gun, and the like.

These compositions, applied to a substrate, dry at ambient temperature without the involvement of cosolvent or of plasticizer and gives, after drying, a coating without surface tack which has good mechanical behavior, in particular good resistance to rubbing movements, and good behavior toward water.

The performance characteristics of the compositions for leather treatment according to the invention are measured after application by means of tests which are conventional to a person skilled in the art.

The following examples illustrate the invention without limiting it.

Experimental Methods

The effectiveness of various crosslinking agents was demonstrated by the study of the mechanical properties of the films of latex according to the invention and of their swelling in various solvents. These films are obtained by evaporation in a Teflon mold of the dispersion of the film-forming polymer in the presence or absence of a crosslinking agent.

Tensile Test:

The elastic modulus and the yield stress were determined from tensile experiments carried out at ambient temperature with an Instrom model 5564 tensile testing device equipped with a 10N force sensor (accuracy +/−2%). These tensile experiments were carried out on rectangular test specimens with a width of 5 mm and a thickness of approximately 250 μm cut out from the films with a punch. These test specimens are stored at 23° C. and 50% relative humidity for 7 days before the measurements. The initial distance between the jaws which hold the test specimen is typically 25 mm. The pull rate used is 10 mm/min.

Measurement of the Swelling

The swellings of the films were measured in three solvents: water, ethanol (EtOH) and methyl ethyl ketone (MEK). The swelling experiments were carried out on rectangular test specimens with a thickness of approximately 500 μm cut out from the films with a punch. The length and width of the test specimens used for the swelling measurements in water are 50 mm and 25 mm respectively. They are only 25 and 10 mm for the swelling measurements in ethanol and methyl ethyl ketone.

These test specimens are stored at 23° C. and 50% relative humidity for 7 days before the measurements. The test specimens are immersed in each solvent for 24 hours at ambient temperature and are then superficially dried and weighed. The swelling S is then expressed by the following ratio:

S=100*(Ms−Md°)/Md°

where Md° is the dry mass of the film before immersion in the solvent and Ms the mass of the swollen film after immersion in the solvent.

In order to evaluate the contribution of the compositions for leather finishing according to the invention, the following characteristics of various finishes were determined using tests known in the trade:

adhesion of the finish to leather;

dynamic resistance to the penetration of water (Bally penetrometer);

behavior toward rubbing movements (Veslic).

The adhesion of the finish to the leather is evaluated using a 90° peel test. A test specimen is adhesively bonded with a cyanoacrylate adhesive, finish side, to an aluminum support having a surface area of 10×50 mm². The breaking strength is measured on six test specimens using a tensile testing device (rate: 50 mm/min). After our experiment, the quality of the adhesion of a finish to the leather can be classified in four categories:

for a peel strength of less than 0.6 daN, the failure is systematically adhesive and therefore regarded as poor,

for a strength of between 0.6 and 0.8 daN, the adhesion is regarded as correct and these values are often obtained with commercially available products

when the peel strength is between 0.8 and 1 daN, the adhesion is good and tearing of the grain is observed

for a strength of greater than 1 daN, the failure is cohesive and ripping of the leather is often observed.

The dynamic resistance to the pentration of water of the various finishes is measured using a Bally penetrometer (Standard NFG 52105). The kinetics of absorption of water as a function of the time and not a number of cycles until water passes through are determined. This method is an adaptation of the standard. For this, the uptake in weight of 4 test specimens is measured, after gentle wiping, after stressing for 1, 3, 5 and 7 hours on the Bally penetrometer.

The resistance to rubbing movements under dry conditions or in the presence of solvents (water, ethanol, acetone) is determined in accordance with Standard NFG 52301.

To evaluate the applicative performances of these compositions, use is made of a semifinished full grain calf hide from Costil shaved to 1.6-1.8 mm.

### EXAMPLES

The following abbreviations are used in the examples:

MMA: methyl methacrylate

BuA: n-butyl acrylate

MA: methacrylic acid

EA: ethyl acrylate

BDA: 1,4-butanediol diacrylate

DAM: diallyl maleate

### Example 1

### Preparation of a Latex According to the Invention

The preparation is carried out in two stages in a 5 liter reactor equipped with a stirrer, a temperature recorder and a jacket, through which runs a heat-transfer fluid for maintaining the temperature of the reactor.

1st stage: After degassing with nitrogen, 1480 g of demineralized water and 5 g of disodium phosphate are introduced into this reactor, which is maintained at ambient temperature and with stirring, and then 208 g of a 3.84% by weight aqueous sodium lauryl sulfate solution, as emulsifying agent, and 4.3 g of potassium persulfate, dissolved in 97.7 g of water, are added to this mixture.

The temperature of the contents of the reactor is subsequently brought to 80° C. and then a mixture composed of 722 g of n-butyl acrylate, 309.4 g of methyl methacrylate and 10.9 g of 1,4-butanediol diacrylate is continuously added to said contents over a period of one hour. At the same time, 0.96 g of sodium bisulfite, dissolved in 34 g of water, is added to said contents over a period of one hour. At the end of the addition of the monomers and of the sodium bisulfite solution, the reactor is maintained at 80° C. with stirring for 30 minutes.

The addition is carried out, to the reactor maintained at 80° C., of a mixture composed of 26.5 g of n-butyl acrylate and 5.7 g of diallyl maleate and 4.7 g of a 4.47% by weight aqueous sodium bisulfite solution. Subsequently, a mixture of 66.05 g of methyl methacrylate and of 0.28 g of potassium persulfate dissolved in 6.37 g of water is added to the reaction mixture over 30 minutes. The temperature is maintained at 80° C. for one hour. The soft core of the latex particles is obtained with a conversion of 98.4%, determined by gravimetric analysis.

2nd stage: 1 g of sodium sulfoxylateformaldehyde in 4.2 g of water is added, with stirring, to the reaction mixture obtained above, maintained at 80° C. A mixture of 198.4 g of methyl methacrylate, of 27 g of methacrylic acid and of 75 g of water, on the one hand, and 0.86 g of tert-butyl hydroperoxide in 260 g of water, on the other hand, are subsequently added over a period of one hour.

The contents of the reactor are maintained at 80° C. for 30 minutes after the end of the addition of methyl methacrylate, of methacrylic acid and of the of tert-butyl hydroperoxide and 0.5 g of tert-butyl hydroperoxide and 0.21 g of sodium bisulfite in 10 g of water are added to the contents.

The reaction mixture is subsequently maintained at 80° C. for one hour. At the end of this period, the contents of the reactor are cooled to ambient temperature.

A latex of the grafted copolymer is obtained with a conversion of 98.5%, the diameter of the particles of which (mean by weight, determined by light scattering) is 84 nm and the dry matter of which is 38.4%.

Differential thermal analysis of the polymer obtained shows that it has 2 Tg values, one situated at −10° C. and the other at 108° C.

The pH of the solution is subsequently adjusted to between 8 and 9 using an ammonium hydroxide solution comprising 4.4% of active material.

### Examples 2 to 4

### Preparation of Latex According to the Invention

Dispersions of multiphase polymer particles were prepared according to the method described in example 1. The amounts of monomers and other synthesis additives introduced during the first stage are identical to those in example 1. The contents of monomers introduced in the second stage were modified as shown in table 1 below.

TABLE 1

| | Monomers introduced into the reactor | |
|---|---|---|
| | (% by weight with respect to the total weight | |
| | of the monomers in the particles) | |
| | | In the second |
| Example | In the first stage | stage |
| 2 | 28 MMA/55.9 BuA/0.81 BDA/0.43 DAM | 13.8 MMA/ |
| | | 1.01 MA |
| 3 | 28 MMA/55.9 BuA/0.81 BDA/0.43 DAM | 14.8 MMA |
| 4 | 28 MMA/55.9 BuA/0.81 BDA/0.43 DAM | 13.6 MMA/ |
| | | 1.19 EA |

The contents of crosslinking agent shown in examples 5 and 6 are expressed as % by weight of commercial crosslinking agent with respect to the dry latex.

### Example 5

### Demonstration of the Crosslinking of the Latex of Example 1 by a Polyisocyanate: Bayhydur 3100 from Bayer

The results of the swelling measurements (S) carried out on films of the latex of example 1, which films are prepared in the presence of various contents of Bayhydur 3100, are given in table 2.

TABLE 2

| Content | | | |
|---|---|---|---|
| (%) of | | | |
| Bayhydur | Water | EtOH | MEK |
| 3100 | S (%) | S (%) | S (%) |
| 0 | 27.5 | n.m.* | n.m. |
| 2.8 | 22 | 166 | n.m. |
| 4 | 21 | 149 | n.m. |
| 5.6 | 21 | 127 | 508 |
| 10 | 17.5 | 112 | 284 |
| 20 | 10.5 | 80 | 178 |

*n.m.: not measurable, either latex disperses completely in the solvent or the film is too brittle and disintegrates when removed from the solvent.

These measurements indicate a sharp reduction in the swelling of the latex films in water, ethanol and MEK in the presence of Bayhydur 3100.

The results of the measurements of mechanical properties carried out on films of the latex of example 1, which films are prepared in the presence of various contents of Bayhydur 3100, are given in table 3.

TABLE 3

| Content (%) | | | |
|---|---|---|---|
| of Bayhydur | E | y σ | break σ |
| 3100 | (MPa) | (MPa) | (MPa) |
| 0 | 128 | 3.87 | 5.3 |
| 5.6 | 135 | 4.9 | 7.5 |
| 10 | 150 | 4.8 | 7.6 |
| 20 | 190 | 5.1 | 9 |

The increase in the content of Bayhydur 3100 results in a significant strengthening of the mechanical properties of the films, characteristic of their crosslinking, with in particular an increase in their elastic modulus, in their yield stress and in their breaking stress.

These results for swelling and mechanical properties thus clearly demonstrate the effectiveness of Bayhydur 3100 in crosslinking the latex of example 1, strengthening the mechanical properties of the films and reducing their sensitivity to the solvents.

### Example 6

### Demonstration of the Crosslinking of the Latex of Example 1 by Polyaziridine: CX100 from Zeneca

The results of the swelling measurements (S) carried out on films of the latex of example 1, which films are prepared in the presence of various contents of CX100, are given in table 4.

TABLE 4

| Content | | | |
|---|---|---|---|
| (%) in | Water | EtOH | MEK |
| CX100 | S (%) | S (%) | S (%) |
| 0 | 27.5 | n.m.* | n.m. |
| 0.5 | 9 | 99 | 227 |
| 0.8 | 6 | 71 | 332 |

*n.m.: not measurable, the latex completely disperses in the solvent

These swelling measurements indicate a sharp reduction in the swelling of the latex films in water, ethanol and MEK in the presence of a very low content of CX100.

The results of the measurements of mechanical properties carried out on films of the latex of example 1, which films are prepared in the presence of 0.8% of CX100, are given in table 5.

TABLE 5

| Content (%) | E | y σ | break σ |
|---|---|---|---|
| of CX100 | (MPa) | (MPa) | (MPa) |
| 0 | 128 | 3.87 | 5.3 |
| 0.8 | 113 | 4.4 | 7.4 |

The addition of a very small content of CX100 leads to a significant increase in the yield stress and in the breaking stress of the films, which are characteristic of their crosslinking.

These results for swelling and mechanical properties also clearly demonstrate the effectiveness of CX100, at a very low content, in crosslinking the latex of example 1, strengthening the mechanical properties of the films and reducing their sensitivity to the solvents.

### Examples 7 and 8

### Evaluation of the Compositions According to the Invention in the Binder Application

Two coats were applied in order to carry out this evaluation.

A base coat, with the composition:

| | |
|---|---|
| water | 50 parts |
| latex: blend of two acrylic | 30 parts |
| emulsions, Repolem 3911-3110 | |
| (50/50) from Elf Atochem | |
| black pigment (Lepton Black | 20 parts |
| from Bayer) | |

This base coat formulation has a solids content of 15%. It is applied using a compressed-air spray gun in a cross coat. The amount deposited is between 100 and 120 g/m². The base coat is dried at 70° C. for 20 minutes and then glazed for 15 seconds at 70° C. under a load of the order of 1 tonne/m².

A binder, applied in the same way, with the composition:

| | |
|---|---|
| water | 50 parts |
| latex (according to | 30 parts |
| examples 1 to 4) | |
| black pigment | 20 parts |

As above, the content of dry matter in the binder is 15%. In contrast to the normal mode of use of a binder, which is generally transparent, a pigment was introduced during our trials in order to make possible a better evaluation of the behavior of the finish toward rubbing movements under dry conditions or in the presence of solvents (water, acetone, ethanol). This final coat is dried at 70° C. for 20 minutes and then glazed at 70° C. for 15 seconds under a load of 1 tonne/m². The amount of binder deposited is between 60 and 80 g/m². The binder is applied without difficulty to the base coat. The spreading thereof is good. The various finishes do not exhibit tack and the hand of the leather is good. The feel obtained with the various finishes claimed is very different from that obtained with a polyurethane, acrylic or nitrocellulose-based binder.

With the aim of thoroughly demonstrating the advantage of the compositions for leather treatment prepared according to the invention, use was made, as control binders, of a polyurethane emulsion from Bayer (Bayderm 85 UD) and of an acrylic emulsion from Rohm & Haas (Hydrholac AQS). The Bayderm 85UD emulsion was, in addition, evaluated after crosslinking by Bayderm Fix UCL from Bayer.

### Example 7

### Influence of the Content of Acid Functional Groups in the Shell

| | | | | | Bayderm | Hydrholac |
|---|---|---|---|---|---|---|
| | | Synthesis 3 | Synthesis 2 | Synthesis 1 | 85 UD | AQS |
| Content of acid | | 0% | 1.01% | 2% | — | — |
| Bally: | 1 h | 7.2 +/− 0.5 | 10.5 +/− 2.5 | 20.2 +/− 2.4 | 60.7 +/− 2.5 | 10.9 |
| | 3 h | 13.5 +/− 1.5 | 22.7 +/− 5.9 | 44.7 +/− 3.6 | 117 +/− 2.6 | 18.2 |
| | 5 h | 15.7 +/− 2.1 | 36.4 +/− 9.5 | 65.4 +/− 5.3 | — | 22.3 |
| | 7 h | 17.7 +/− 2.3 | 44.2 +/− 10.5 | 80.4 +/− 6.8 | — | 27.8 |

| | | | | | |
|---|---|---|---|---|---|
| Behavior toward rubbing | 5 | 5 | 5 | 5 | 5 |
| movements under dry | | | | | |
| conditions (150 cycles) | | | | | |
| Water (150 cycles) | 5 | 3 | 2 | 2 | 1 |
| Ethanol (10 cycles) | 1 | 1 | 1 | 1 | 1 |
| Acetone (10 cycles) | 1 | 1 | 1 | 1 | 1 |
| Adhesion (daN) | 1.3 | 2.4 | 3 | 3.2 | 0.9 |

The introduction of acid functional groups into the shell leads to an improvement in the adhesion of the finish. This is because an increase in the peel strength is observed with the concentration of acidic monomers, although a peel strength of greater than 1 daN often results in cohesive failure of the leather.

In comparison with a noncrosslinked polyurethane finish (Bayderm 85 UD), the finishes claimed by the Applicant Company lead to better behavior with the Bally device, whatever the level of acid functional groups, and to superior or equivalent behavior toward rubbing movements.

In comparison with a commercial acrylic finish (Hydrholac AQS), the presence of acid functional groups leads to an increase in the uptake of water in the Bally test. In constrast, the other properties of this competitive finish are inferior to those obtained with the finishes claimed by the Applicant Company.

### Example 8

### Influence of the Crosslinking of the Functional Monomers of the Shell

To compensate for the sensitivity to water, it is possbile to use an external crosslinking agent which reacts with the acid functional groups. Thus, by adjusting the level of crosslinking agent, it is possible to retain good adhesion to the leather and to reduce the sensitivity to water, and the resistance to solvents can be improved. It is well known to a person skilled in the art (R. G. Coogan, Progress in organic coatings, 32, p. 51-63 (1997), “Post-crosslinking of water-borne urethanes”) that multifunctional compounds, such as polyaziridines, for example CX 100 from Zeneca Resins, polycarbodiimides, for example Ucarlink XL 29 SE from Union Carbide or Bayderm Fix UCL from Bayer, polyepoxy compounds or polyisocyanates in aqueous dispersion, for example Bayhydur 3100 from Bayer (G. Oertel, “Polyurethane Handbook”, Hanser Publishers, 1994), make possible the postcrosslinking of latices comprising acid functional groups. The contribution of postcrosslinking with a polyisocyanate in aqueous dispersion (Bayhydur 3100) was therefore evaluated on the compositions claimed by the Applicant Company. The content of Bayhydur 3100 shown in the following table is expressed as % by weight of commercial crosslinking agent with respect to the dry latex.

The control polyurethane latex was also crosslinked by means of a polycarbodiimide, Bayderm Fix UCL from Bayer. In this case, the proportion of crosslinking agent added is expressed in the form of a percentage by weight of the crosslinking agent in its commercial presentation with respect to the latex, itself also in its commercial presentation.

| Polymer | | Synthesis 1 | | Bayderm 85 UD | | |
|---|---|---|---|---|---|---|
| Crosslinking agent | | — | +5.6% | — | +Fix UCL | +Fix UCL |
| | | | Bayhydur | | 1% | 5% |
| | | | 3100 | | | |
| Content of acid | | 2% | — | — | | |
| Bally: | 1 h (%) | 20.2 +/− 2.4 | 5.9 +/− 0.6 | 60.7 +/− 2.5 | 10.7 +/− 2.6 | 11 +/− 1.2 |
| | 3 h (%) | 44.7 +/− 3.6 | 7.8 +/− 0.7 | 117 +/− 2.6 | 20.5 +/− 5.6 | 17.6 +/− 1.2 |
| | 5 h (%) | 65.4 +/− 5.3 | 9.5 +/− 0.5 | — | 28.8 +/− 9.9 | 21.7 +/− 1.4 |
| | 7 h (%) | 80.4 +/− 6.8 | 10.9 +/− 1.0 | — | 34.8 +/− 13.8 | 22.4 +/− 2.1 |

| | | | | | |
|---|---|---|---|---|---|
| Behavior toward rubbing | 5 | 5 | 5 | 5 | 5 |
| movements under dry | | | | | |
| conditions (150 cycles) | | | | | |
| Water (150 cycles) | 2 | ¾ | 2 | 2 | 2 |
| Ethanol (10 cycles) | 1 | 1 | 1 | 1 | 1 |
| Acetone (10 cycles) | 1 | ½ | 1 | 1 | 1 |
| Adhesion (daN) | 3 | 4.2 | 3.2 | 2.2 | 2 |

The introduction of a polyisocyanate as postcross-linking agent into the claimed compositions results not only in a sharp reduction in the water uptake during the Bally test but also improves the behavior toward rubbing movements in the presence of water and of acetone and increases the adhesion of the finish.

The postcrosslinking of the polyurethane finish also results in a decrease in the water uptake during the Bally test. However, all the properties of the crosslinked finish according to the invention are superior to those obtained after crosslinking the polyurethane finish.

Furthermore, the composition for leather finishing, prepared according to the invention with the latex of example 1 and Bayhydur 3100 with a solids content of 15% by weight, has a very good pot stability. The latter proved to be greater than 3 weeks at ambient temperature.

1. An aqueous composition for the treatment of leather, comprising:
(a) an aqueous dispersion of multiphase polymer particles in which the polymer particles comprise at least two distinct phases:
a first internal phase formed by a polymer P1 with a soft nature having a glass transition temperature (Tg1) of less than 20° C.; and
a second external phase formed by a polymer P2 with a hard nature having a glass transition temperature (Tg2) of greater than 60° C. and being able to comprise reactive functional monomers; the hard polymer P2 being grafted to the soft polymer P1 directly or by the introduction onto the latter of residues from monomer units;
(b) optionally at least one crosslinking agent which reacts with the functional monomers of the external phase, the amount of crosslinking agent (b) being between 0 and 20% by weight with respect to the weight of the dispersion (a);
(c) optionally at least one other acrylic, polyurethane or polyurethane-acrylic latex;
(d) optionally at least one additive;
the total content of active material in said composition being between 5 and 30% by weight.

2. The composition as claimed in claim 1, characterized in that the polymer P1 has a Tg1 of less than 5° C. and the polymer P2 a Tg2 of greater than 60° C.

3. The composition as claimed in either of claims 1 and 2, characterized in that the polymer P1 represents 70 to 90% by weight of the particles and the polymer P2 represents 10 to 30% by weight of the particles.

4. The composition as claimed in one of claims 1 to 3, characterized in that the polymer P1 has a greater hydrophobicity than that of the polymer P2.

5. The composition as claimed in one of claims 1 to 4, characterized in that the polymer P1 and P2 comprise:
from 90 to 100% by weight of units obtained by polymerization of at least one monomer chosen from the group (I) consisting of (C₁-C₁₆)alkyl esters of (meth)acrylic acid, such as methyl (meth)acrylate, ethyl (meth)acrylate and butyl (meth)acrylate, hydroxyalkyl esters of (meth)acrylic acid, vinyl esters of linear or branched carboxylic acids, such as vinyl acetate and vinyl stearate, styrene, alkylstyrenes, such as methylstyrene, haloalkylstyrenes, such as chloromethylstyrene, (meth)acrylamide, acrylonitrile, vinyl chloride, (meth)acrylic acids and their derivatives, such as anhydrides, monomers comprising acidic or basic functional groups, such as itaconic acid, fumaric acid, crotonic acid or maleic acid, silanated (meth)acrylic or vinyl monomers, such as methacryloxypropyltriethoxy- or methacryloxy-propyltriisopropoxysilane, and monomers comprising acetoacetoxy groups, such as acetoacetoxyethyl (meth)acrylate, and
from 0 to 10% by weight of units obtained by polymerization of at least one monomer chosen from the group (II) consisting of allyl esters of monocarboxylic or dicarboxylic acids, such as allyl acrylate, allyl methacrylate and diallyl maleate or phthalate, conjugated dienes, such as butadiene and isoprene, polyol poly(meth)acrylates, such as ethylene glycol or triethylene glycol dimethacrylate, 1,3- or 1,4-butylene glycol dimethacrylate, 1,4-butanediol diacrylate and pentaerythritol tetraacrylate, or trimethylolpropane triacrylate, polyvinylbenzenes, such as divinylbenzene or trivinylbenzene, and polyallyl derivatives, such as triallyl cyanurate, triallyl isocyanurate and triallyl trimesate.

6. The composition as claimed in claim 5, characterized in that:
for the polymer P1, the monomers are chosen from butyl acrylate or methacrylate, methyl acrylate or methacrylate, ethyl acrylate or methacrylate, 2-ethylhexyl acrylate or methacrylate, or styrene; and
for the polymer P2, the monomers are chosen from methyl methacrylate, styrene, vinyl chloride, acrylic or methacrylic acid, itaconic acid, maleic acid, or hydroxyethyl acrylate or methacrylate.

7. The composition as claimed in one of claims 1 to 6, characterized in that the polymer P2 comprises at least 50% by weight of hydrophobic monomers.

8. The composition as claimed in one of claims 1 to 7, characterized in that the residues from the monomer units which make possible the grafting of the polymer P2 to the polymer P1 are chosen from conjugated dienes and allyl esters of α,β-unsaturated carboxylic or dicarboxylic acids.

9. The composition as claimed in one of claims 1 to 8, characterized in that the functional monomers which can participate in the composition of the polymer P2 in a proportion of up to 19% by weight are chosen from acidic, hydroxylated or epoxidized monomers.

10. The composition as claimed in one of claims 1 to 8, characterized in that the content of dry matter of the dispersion (a) is between 10 and 50% by weight, preferably between 20 and 45% by weight.

11. The composition as claimed in one of claims 1 to 10, characterized in that the amount of the dispersion (a) in the composition is between 10% and 80% by weight, preferably between 10 and 20% by weight.

12. The composition as claimed in one of claims 1 to 11, characterized in that the dispersion (a) is a dispersion which comprises neither cosolvent nor plasticizer and which forms a film by evaporation at a temperature of less than 60° C.

13. The composition as claimed in one of claims 1 to 12, characterized in that the crosslinking agent or agents (b) are chosen from the group consisting of epoxides, hydrazide derivatives, polyisocyanates and polycarbodiimides, preferably being introduced in a proportion of 0.1 to 10% by weight of the total weight of the dispersion (a).

14. The composition as claimed in one of claims 1 to 13, characterized in that the functional monomers present in the external phase P2 are chosen from acrylic acid or methacrylic acid and the crosslinking agent (c) is a polyisocyanate.

15. The composition as claimed in one of claims 1 to 14, characterized in that its total content of active material is between 10 and 20% by weight.

16. The use of the composition as defined in one of claims 1 to 15 in the treatment of leather, in particular as composition for finishing and more particularly as binder.

17. A process for the preparation of the composition as defined in one of claims 1 to 15, characterized in that the desired additives are added, with stirring, to the dispersion of film-forming polymer or the dispersion of film-forming polymer is added to an aqueous base comprising these additives.

18. A process for the treatment of leather, characterized in that the composition as defined in one of claims 1 to 15 is applied to the leather, in particular with a brush, with a plush applicator or with a spray gun, and in that drying is allowed to take place at ambient temperature.

19. A leather treated with the composition as defined in one of claims 1 to 15.
